(19) United States
(12) Patent Application Publication
(10) Pub. No.: US 2020/0097232 A1
(43) Pub. Date: Mar. 26, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Toshiaki NAKAHARA, Kanagawa (JP)

(73) Assignee: FUJI XEROX CO., LTD., Tokyo (JP)

(21) Appl. No.: 16/565,499

(22) Filed: Sep. 10, 2019

(30) Foreign Application Priority Data
Sep. 20, 2018 (JP) 2018-175960

(51) Int. Cl. G06F 3/12; G06K 9/34; H04N 1/00

(52) U.S. Cl. CPC G06F 3/1238; G06K 9/344; G06K 2209/01; G06F 3/1222; H04N 1/00331; H04N 1/0048

(57) ABSTRACT

An information processing apparatus includes a receiving unit, a classifying unit, and an executing unit. The receiving unit receives an execution command for a process. The classifying unit classifies the process corresponding to the execution command as any of categories prepared in advance based on a character string included in an object to be processed in the process. The executing unit executes the process in accordance with the execution command received by the receiving unit.

### CROSS-REFERENCE TO RELATED APPLICATIONS

This application is based on and claims priority under 35 USC 119 from Japanese Patent Application No. 2018-175960 filed Sep. 20, 2018.

### BACKGROUND

### (i) Technical Field

The present disclosure relates to information processing apparatuses and non-transitory computer readable media.

### (ii) Related Art

In a case where a document has a specific character string that is to be desirably prohibited from being disclosed to the outside in the related art, for example, Japanese Unexamined Patent Application Publication No. 2005-018699 proposes a technology for prohibiting the document from being transmitted via electronic mail or from being posted on a website.

However, even if there is such a technology for controlling the execution of a process, such as mail transmission, in accordance with a character string included in an object to be processed, for example, it is not determined whether or not the process to be executed is appropriate, or the object is not classified into multiple categories for control.

### SUMMARY

Aspects of non-limiting embodiments of the present disclosure relate to classifying a process as a relevant category in accordance with a character string included in an object to be processed.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing apparatus including a receiving unit, a classifying unit, and an executing unit. The receiving unit receives an execution command for a process. The classifying unit classifies the process corresponding to the execution command as any of categories prepared in advance based on a character string included in an object to be processed in the process. The executing unit executes the process in accordance with the execution command received by the receiving unit.

### BRIEF DESCRIPTION OF THE DRAWINGS

An exemplary embodiment of the present disclosure will be described in detail based on the following figures, wherein:

FIG. 1 is a block diagram of a multifunction apparatus according to an exemplary embodiment;

FIG. 2 illustrates a hardware configuration of the multifunction apparatus according to the exemplary embodiment;

FIG. 3 illustrates a data configuration example of a term table according to the exemplary embodiment;

FIG. 4 illustrates a data configuration example of a control table according to the exemplary embodiment;

FIG. 5 is a flowchart illustrating a category classification process according to the exemplary embodiment;

FIG. 6 illustrates image logs corresponding to jobs handled in accordance with the exemplary embodiment;

FIG. 7 illustrates a data configuration example of classification result information stored in a classification-result-information storage unit according to the exemplary embodiment;

FIG. 8 illustrates an example of a compilation result of the classification result information in accordance with the exemplary embodiment; and

FIG. 9 illustrates another example of the compilation result of the classification result information in accordance with the exemplary embodiment.

### DETAILED DESCRIPTION

An exemplary embodiment of the present disclosure will be described below with reference to the drawings.

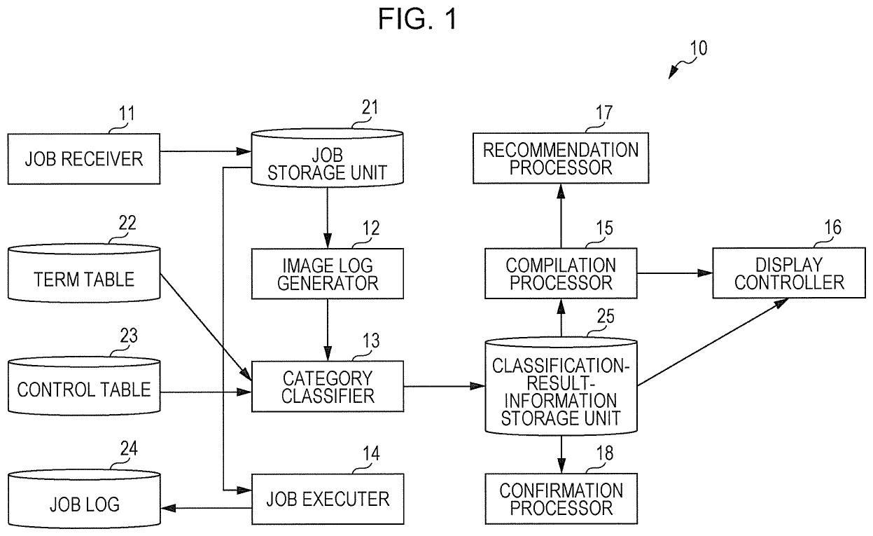

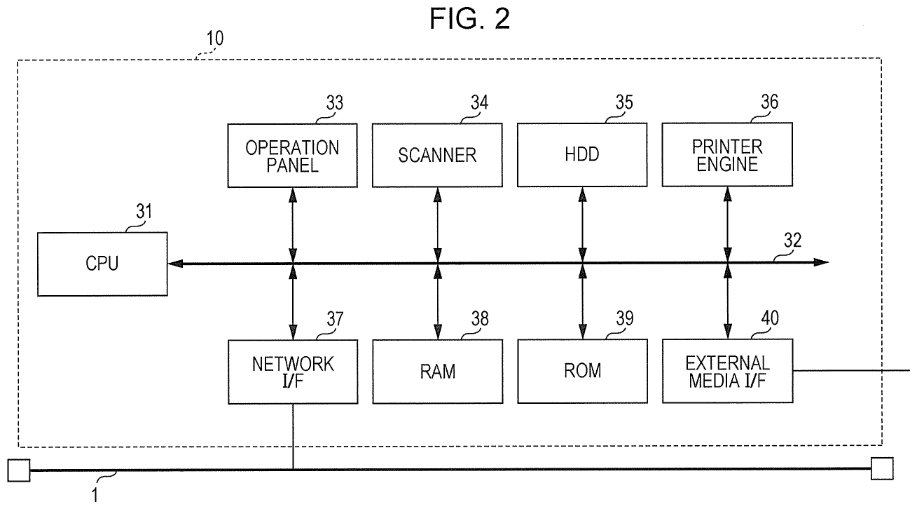

FIG. 1 is a block diagram of a multifunction apparatus 10 according to this exemplary embodiment. FIG. 2 illustrates a hardware configuration of the multifunction apparatus 10 according to this exemplary embodiment. The multifunction apparatus 10 is an example of an image forming apparatus having various types of functions, such as a copying function and a scanning function, and contains a computer (information processing device) therein. In FIG. 2, a central processing unit (CPU) 31 controls the operation of various types of mechanisms equipped in the apparatus, such as a scanner 34 and a printer engine 36, in accordance with a program stored in a read-only memory (ROM) 39. An address data bus 32 connects with the various types of mechanisms to be controlled by the CPU 31 so as to perform data communication. An operation panel 33 receives a command from a user and displays information. The scanner 34 reads a document set by the user and stores electronic data of the read document in a hard disk drive (HDD) 35. The HDD 35 stores therein, for example, the electronic document read by using the scanner 34. The printer engine 36 prints an image onto an output sheet in accordance with a command from a control program executed by the CPU 31. A network interface (I/F) 37 connects with a network 1 and is used for transmitting electronic data generated by the apparatus, receiving an electronic mail transmitted to the apparatus, and also accessing the apparatus via a browser. A random access memory (RAM) 38 is used as a work memory when a program is executed or as a communication buffer when electronic data is exchanged. The ROM 39 stores therein various types of programs related to controlling of the apparatus, encryption of electronic data, and exchanging of electronic data. The various types of programs are executed so that components to be described below exhibit predetermined processing functions. An external media interface (I/F) 40 is an interface for an external memory device, such as a universal serial bus (USB) memory or a flash memory.

Referring back to FIG. 1, the multifunction apparatus 10 according to this exemplary embodiment includes a job receiver 11, an image log generator 12, a category classifier 13, a job executer 14, a compilation processor 15, a display controller 16, a recommendation processor 17, a confirmation processor 18, a job storage unit 21, a term table 22, a control table 23, a job log 24, and a classification-result-information storage unit 25. Components not used for explaining this exemplary embodiment are not shown in the drawings.

The job receiver 11 receives a job transmitted as a process execution command and registers the job in the job storage unit 21. The image log generator 12 generates a log file expressing an image of an object to be processed in the received job. An “object” is, for example, a text file or an image file to be processed in a job, such as printing or mail transmission. A “log file” is a file generated for recording an object to be processed in a job and has lower resolution, for reducing the storage capacity, than image data to be generated by actually processing the object in the job.

The category classifier 13 refers to the term table 22 and also the control table 23, where necessary, based on a character string included in the image log generated from the object, so as to classify the job as any of categories prepared in advance. Moreover, the category classifier 13 refers to the control table 23 to determine whether or not it is appropriate to execute the job. The job executer 14 executes the job received by the job receiver 11 and registered in the job storage unit 21, and registers log information related to an execution result of the job in the job log 24. The classification-result-information storage unit 25 contains classification result information indicating the classification result obtained by the category classifier 13 classifying the job as any of the categories, and the compilation processor 15 refers to the classification result information and executes a compilation process, such as compiling the number of executed processes (jobs) for each category. For outputting the classification result information and the compilation result obtained by the compilation processor 15, the display controller 16 controls displaying of the classification result information and the compilation result on the operation panel 33 and a personal computer (PC) of a manager. The recommendation processor 17 recommends execution of a predetermined process if the compilation value obtained by the compilation processor 15 exceeds a predetermined threshold value. The confirmation processor 18 confirms whether or not it is appropriate to execute the process (job) classified as any of the categories as a result of corresponding to a candidate term set in the term table 22.

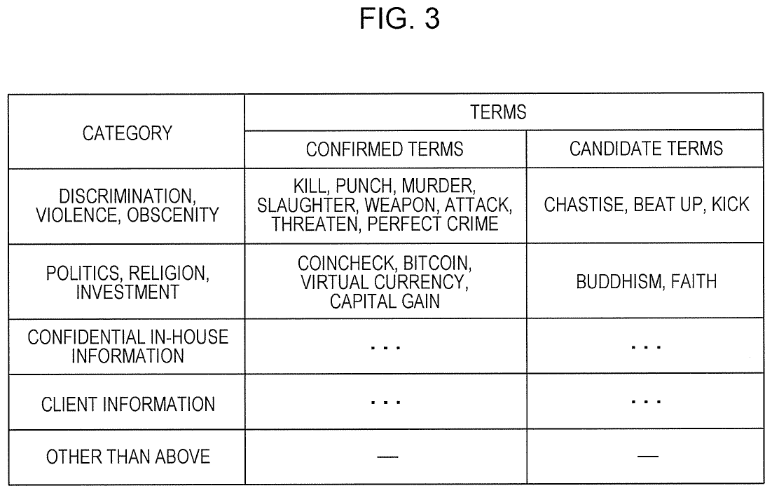

FIG. 3 illustrates a data configuration example of the term table 22 according to this exemplary embodiment. In the term table 22, terms classified as confirmed terms and candidate terms are set in correspondence with each other for each category. The categories are prepared in advance for classifying jobs. Therefore, each job is classified as any of the categories. In this exemplary embodiment, the prepared categories include a “discrimination, violence, obscenity” category, a “politics, religion, investment” category, a “confidential in-house information” category, a “client information” category, and an “other than above” category. These categories are merely examples, and the types and number of categories are not limited thereto. The “other than above” category is where a job not applicable to any of the above four categories is classified. Therefore, it may be not necessary to set terms in the “other than above” category.

In this exemplary embodiment, if a character string included in an image log corresponding to a job matches any one of terms (confirmed term or candidate term) corresponding to any of the categories, as will be described below, the job is classified as the relevant category. However, for the sake of convenience, it may sometimes be simply described that a character string included in a job matches a term in any of the categories, or that a term corresponding to a category is included in a job.

A “confirmed term” set in the term table 22 is a term for confirming that it is inappropriate to execute a job if the job includes a character string that matches the relevant confirmed term. A “candidate term” is a term for assuming that it may possibly be inappropriate to execute a job if the job includes a character string that matches the relevant candidate term.

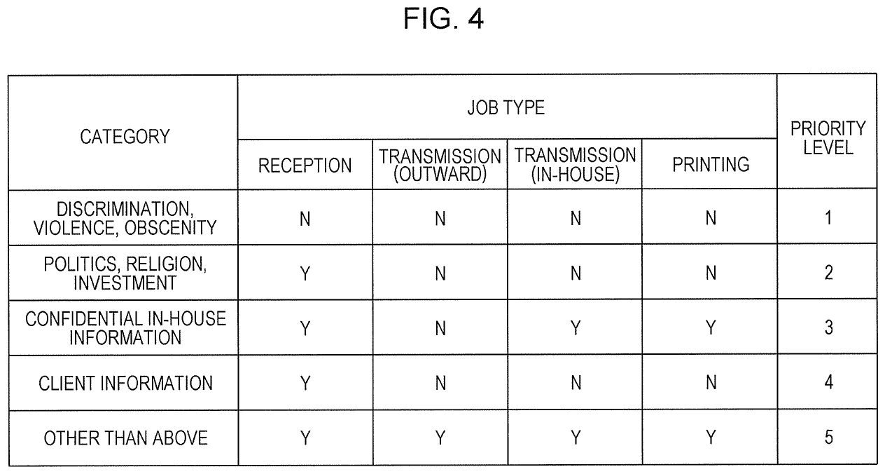

FIG. 4 illustrates a data configuration example of the control table 23 according to this exemplary embodiment. In the control table 23, job types and a priority level are set in correspondence with each category. The categories are the same as those described with reference to the term table 22, meaning that the same categories as those in the term table 22 are set. The job types are those handled by the multifunction apparatus 10. This exemplary embodiment relates to an example where mail reception (reception), mail transmission to an outside user (transmission (outward)), mail transmission to an in-house user (transmission (in-house)), and printing are handled. These job types are merely examples and are not necessarily limited in terms of these types and number.

For each category under each job type, a “Y” (for “yes”) or an “N” (for “no”) is set in advance. A “Y” indicates that it is appropriate to execute the job of the relevant type. An “N” indicates that it is not appropriate to execute the job of the relevant type. For example, in a case of a job including the character string “virtual currency”, the job is classified as the “politics, religion, investment” category by referring to the term table 22. According to the setting example of the control table 23 shown in FIG. 4, a “Y” is set for the reception with respect to the “politics, religion, investment” category, whereas an “N” is set for the remaining job types. Thus, it is not inappropriate to perform mail reception of an object corresponding to the job including this character string “virtual currency”, but it is not appropriate, that is, inappropriate, to perform outward and in-house mail transmission or to perform printing.

A priority level is set for each category. In a case where an image log includes multiple character strings, it is assumable that the image log has a mixture of character strings that match multiple terms belonging to different categories in the term table 22. For example, in a case where an image log includes the character strings “punch” and “virtual currency”, the character string “punch” is set in correspondence with the “discrimination, violence, obscenity” category, and the character string “virtual currency” is set in correspondence with the “politics, religion, investment” category.

In this case, it may be necessary to narrow down the job categories into a single category. A priority level is information prepared for narrowing down categories into a single category in this manner. In the case of this exemplary embodiment, a job is classified as a category with a higher priority level (i.e., with a smaller value indicating a priority level).

The classification-result-information storage unit 25 has registered therein a job classification result obtained by the multifunction apparatus 10 executing the job. Classification result information to be registered in the classification-result-information storage unit 25 will be described later together with the description of the operation.

The components 11 to 18 in the multifunction apparatus 10 are realized as a result of cooperative operation between the computer equipped in the multifunction apparatus 10 and a program executed by the CPU 31 equipped in the computer. The storage units 21 to 25 are realized by the HDD 35 or the RAM 38 equipped in the multifunction apparatus 10. Alternatively, an external storage unit may be used via a network.

The program used in this exemplary embodiment may be provided via a communication unit or may be provided by being stored in a computer readable storage medium, such as a compact disc read-only memory (CD-ROM) or a USB memory. The program provided via the communication unit or from the storage medium is installed in the computer, and the CPU of the computer sequentially executes the program so that various types of processes are realized.

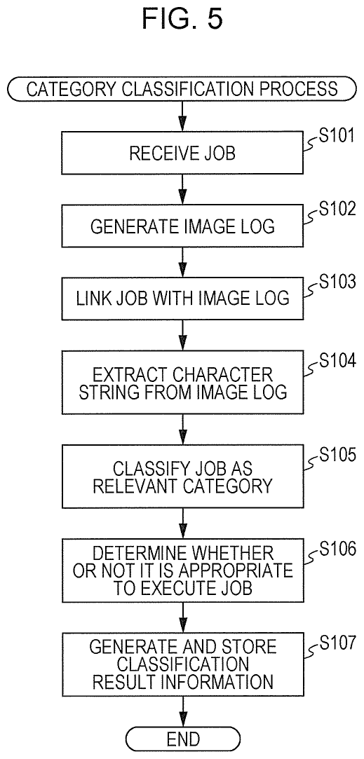

Next, the operation according to this exemplary embodiment will be described. In this exemplary embodiment, a received job is classified as any of the categories, and it is determined whether or not it is appropriate to execute the job. The following description with reference to a flowchart shown in FIG. 5 relates to the category classification process.

In step S101, when the job receiver 11 receives a job transmitted from, for example, a user PC via the network 1, the job receiver 11 registers the job in the job storage unit 21. Although the job executer 14 executes the received job, generates log information, and registers the log information in the job log 24, such a process is performed independently from the category classification process to be described below. Therefore, such a process related to job execution is not included in FIG. 5. The present process is intended for determining whether or not it is appropriate to execute a job, but is not intended for controlling the execution of the job.

When the job receiver 11 receives the job, the image log generator 12 generates an image log from an object to be processed in the received job in step S102, and links the generated image log with the job in step S103.

When the image log is generated by the image log generator 12, the category classifier 13 classifies the job as any of the categories. In order to achieve this, the category classifier 13 extracts a character string from the image log in accordance with an optical character recognition (OCR) analysis in step S104. Although the category classifier 13 according to this exemplary embodiment refers to the image log when extracting a character string, the category classifier 13 may alternatively refer to the object itself since the image log and the object are data with the same contents.

Subsequently, in step S105, the category classifier 13 refers to the term table 22 and classifies the job as any of the categories based on the extracted character string. This category classification process will be described in detail with reference to a specific example.

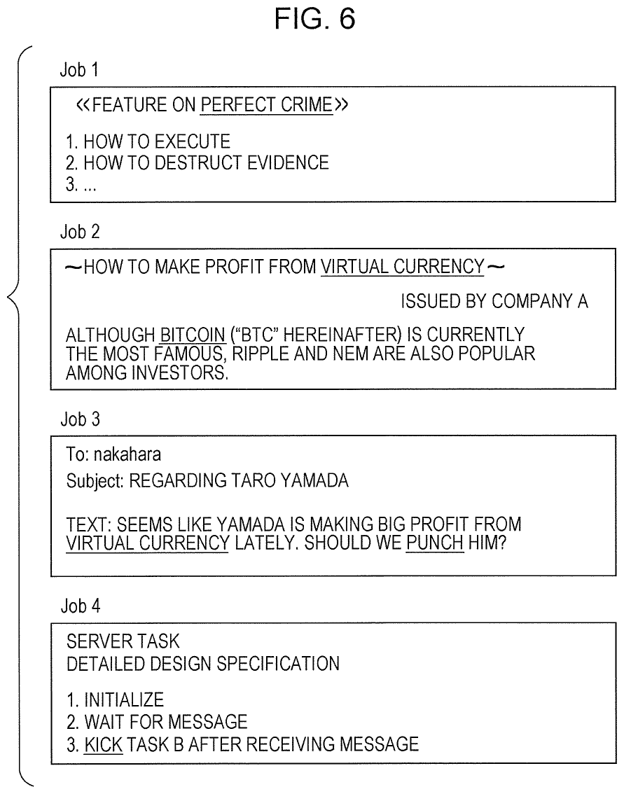

FIG. 6 illustrates image logs corresponding to jobs (i.e., Job 1 to Job 4). In each image log, a character string that matches a term set in the term table 22 is underlined.

First, referring to the image log of Job 1, this image log includes a character string that matches the term “perfect crime” registered in the term table 22. This character string only matches a confirmed term included in the “discrimination, violence, obscenity” category. Therefore, the category classifier 13 classifies Job 1 as the “discrimination, violence, obscenity” category.

Subsequently, referring to the image log of Job 2, this image log includes character strings that match the terms “virtual currency” and “bitcoin” registered in the term table 22. These character strings only match confirmed terms included in the “politics, religion, investment” category. Therefore, the category classifier 13 classifies Job 2 as the “politics, religion, investment” category.

Next, referring to the image log of Job 3, this image log includes character strings that match the terms “virtual currency” and “punch” registered in the term table 22. The character string “virtual currency” only matches a confirmed term included in the “politics, religion, investment” category. In contrast, the character string “punch” only matches a confirmed term included in the “discrimination, violence, obscenity” category. In a case where terms of different categories are mixed in an image log as in this example, the category classifier 13 refers to the control table 23 and narrows down the categories into a single category.

Specifically, since a priority level is set for each category in the control table 23, each job is classified as the category with the higher priority level by referring to this priority level. According to the setting example of the priority levels shown in FIG. 4, since the “discrimination, violence, obscenity” category has the higher priority level, the category classifier 13 classifies Job 3 as the “discrimination, violence, obscenity” category.

For simplifying the description, this example relates to a case where a job includes one character string and one character string that respectively match terms (confirmed terms or candidate terms) of different categories. However, it is conceivable that an image log of a job includes multiple character strings that match terms (confirmed terms or candidate terms) per single category. One example is a case where an image log includes multiple confirmed terms that correspond to the “politics, religion, investment” category, namely, “virtual currency” and “bitcoin”. In this case, the priority level of the relevant category may be calculated by, for example, adding together the priority levels in accordance with the number of appearances of the character strings corresponding to the relevant category, and the priority levels of the categories may then be compared with each other so as to determine a category serving as a classification destination. In this exemplary embodiment, a single term is basically set in a single category alone, so that a job is classified as any of the categories. Alternatively, assuming that a category serving as a classification destination is determined by performing calculation in accordance with the number of appearances of terms, a single term may be set in different categories. Moreover, although a priority level is set for each category in this exemplary embodiment, a priority level may be set for each type of term for each category (i.e., separately for confirmed terms and candidate terms).

Furthermore, although different priority levels are set for the respective categories in FIG. 4, the same priority level may be set therefor. By setting the same priority level, it is assumable that a job may have a mixture of character strings of different categories with the same priority level. In this case, the category classifier 13 may cause the operation panel 33 or the manager's PC to display a category selection screen, and may classify the job as a category selected by the user from the screen. Accordingly, the category classifier 13 classifies the job as any of the categories.

Finally, referring to the image log of Job 4, this image log includes the character string “kick”. Referring to the term table 22 shown in FIG. 3, this character string only matches a candidate term included in the “discrimination, violence, obscenity” category. Therefore, the category classifier 13 classifies Job 4 as the “discrimination, violence, obscenity” category.

Subsequently, in step S106, the category classifier 13 determines whether or not it is appropriate to execute the job. A job type may be identified by analyzing the received job. Because the category classifier 13 has already identified the job category and the job type, the category classifier 13 refers to the control table 23 to determine whether or not it is appropriate to execute the job. As mentioned above, a “Y” in the control table 23 indicates that it is appropriate to execute the relevant job, whereas an “N” indicates that it is not appropriate to execute the relevant job. Therefore, it is determinable whether or not it is appropriate to execute the job from the job category and the job type.

Accordingly, when the job category is identified and it is determined whether or not it is appropriate to execute the job, the category classifier 13 generates classification result information and stores the classification result information in the classification-result-information storage unit 25 in step S107.

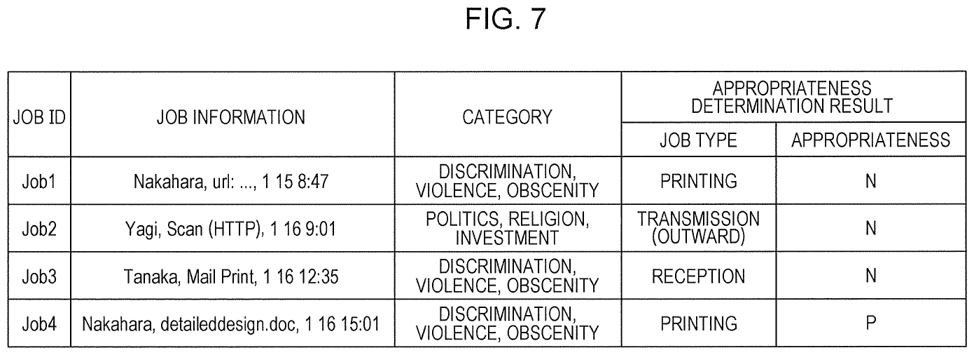

FIG. 7 illustrates a data configuration example of the classification result information set and registered in the classification-result-information storage unit 25 according to this exemplary embodiment. Classification result information is generated for each job by setting identification information (i.e., job ID) of the job in correspondence with job information, a category, and an appropriateness determination result. Job information is related to the relevant job and is obtained from information registered in the job storage unit 21. For example, job information contains information such as the job owner and the job reception time. A category is the category classified in step S105. An appropriateness determination result includes the type of the relevant job and the determination result obtained in step S106 indicating whether or not it is appropriate to execute the job.

With regard to the appropriateness and inappropriateness set in FIG. 7, a “Y” indicates that it is appropriate to execute the relevant job, whereas an “N” indicates that it is not appropriate to execute the relevant job. A “P” (for “possibly inappropriate”) indicates that a character string included in a job matches a candidate term and that it is neither appropriate nor inappropriate to execute the job, but it is determined that there is a possibility of inappropriateness. In the above description, it may be determined whether or not it is appropriate to execute a job by referring to the control table 23. However, since it is uncertain whether or not it is appropriate to execute a job when a character string included in the job matches a candidate term as in this example, the category classifier 13 determines that there is a possibility of inappropriateness in executing Job 4, as shown in FIG. 7.

With regard to a job determined that there is a possibility of inappropriateness, it may be confirmed that it is appropriate or inappropriate to execute the job. Specifically, if a job determined that there is a possibility of inappropriateness exists, that is, if a job that is uncertain as to whether or not it is appropriate to execute the job exists, the confirmation processor 18 causes the operation panel 33 or the manager's PC to display a screen for confirming whether or not it is appropriate to execute the job, and allows the manager to designate appropriateness or inappropriateness via the screen. Accordingly, the confirmation processor 18 may allow the manager to confirm whether or not it is appropriate to execute a job. This confirmation process is executable before or after a compilation process to be described later.

According to this exemplary embodiment, a job is classified as any of the categories in the above-described manner, and it is determined whether or not it is appropriate to execute the job. As the job receiver 11 executes this process on the received job, classification results for a large number of jobs accumulate in the classification result information. In this exemplary embodiment, the compilation processor 15 is provided so as to compile the classification result information.

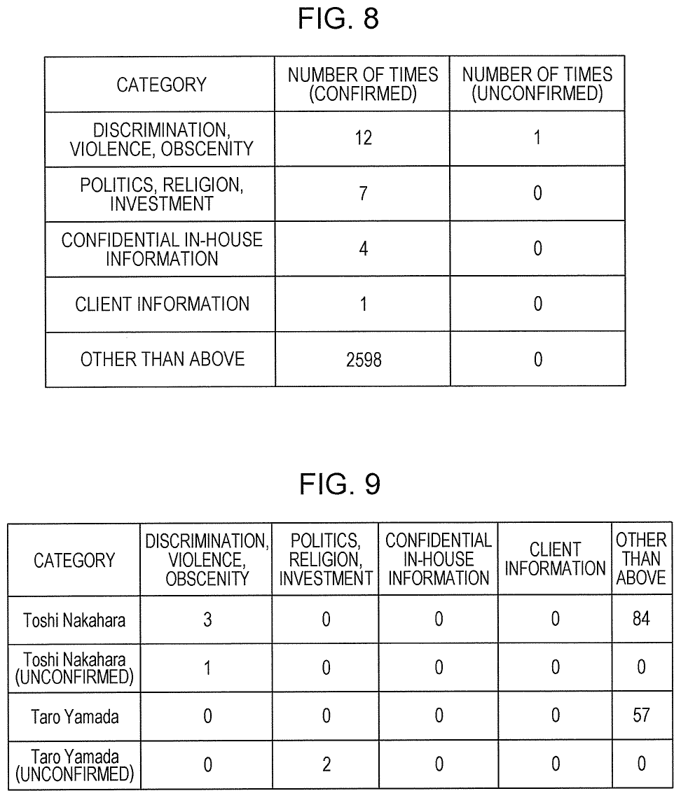

The compilation processor 15 is executed by being activated by, for example, the manager. When the compilation processor 15 is activated, the compilation processor 15 executes the compilation process. Examples of compilation information obtained as a result of this compilation process are shown in FIGS. 8 and 9.

FIG. 8 illustrates a result obtained by compiling the classification result information for each category. The number of times (confirmed) indicates the number of jobs that include character strings that match confirmed terms. Specifically, the number of times (confirmed) indicates the number of jobs that are registered in the classification-result-information storage unit 25 and that are determined to be inappropriate “N” in the appropriateness determination result. The number of times (unconfirmed) indicates the number of jobs that include character strings that match candidate terms. Specifically, the number of times (unconfirmed) indicates the number of jobs that are registered in the classification-result-information storage unit 25 and that are determined that there is a possibility of inappropriateness “P” in the appropriateness determination result.

FIG. 9 illustrates a result obtained by compiling the classification result information for each category and each user who has commanded execution of a job. A user is identifiable by referring to the job information contained in the classification result information. The compilation result shown in FIG. 9 also has jobs determined to be inappropriate “N” and jobs determined that there is a possibility of inappropriateness “P” in the appropriateness determination result.

The display controller 16 performs display control for causing the operation panel 33 or the manager's PC to display the compilation result. Specifically, the display controller 16 controls displaying of a compilation-result display screen on the operation panel 33 in accordance with a predetermined operation from the operation panel 33. Alternatively, a compilation-result display screen (webpage screen) may be generated and displayed on the manager's PC in response to a display request from the manager's PC. In addition to the compilation result, the display controller 16 may also allow displaying of the classification result information. Moreover, although it is assumed that the compilation result is displayed on a screen in this exemplary embodiment, the compilation result may be stored as a file or may be printed. In other words, the output destinations for the compilation result are the HDD 35 and the printer engine 36.

A large compilation value implies that there is a large number of confirmed terms (or candidate terms) used in executed jobs. In some cases, it may be necessary to consider limiting or prohibiting the use of a confirmed term. In this exemplary embodiment, the recommendation processor 17 is provided to assist in the control of execution of a job.

For example, the recommendation processor 17 refers to the compilation result obtained by the compilation processor 15, and if the compilation value exceeds a predetermined threshold value, the recommendation processor 17 notifies the manager of the situation and the relevant job and user, and also recommends execution of a predetermined process. An example of the predetermined process includes recommending installation of a specific program to the manager's PC. Examples of the specific program to be installed include a program that transmits a warning message for limiting execution of a job to the relevant user and a program that limits execution of a job requested by the relevant user.

When the manager receives the notification from the recommendation processor 17, the manager refers to the relevant image log. Then, if it is determinable that the execution of the job is actually inappropriate, the manager installs the recommended program to the manager's PC. Accordingly, the installed program is utilized hereinafter so that it may be expected that execution of an inappropriate job and execution of a job assumed to be inappropriate may be reduced.

Although the installation of the specific program is described above as an example of the predetermined process recommended by the recommendation processor 17, the predetermined process is not limited thereto. For example, the predetermined process to be recommended may include a process in which the manager transmits a warning mail to a user and a process of analyzing the compilation result in more detail.

Although the multifunction apparatus 10 is described as an example of an information processing apparatus in this exemplary embodiment, the exemplary embodiment may also be applied to a client, server, or proxy server capable of executing different types of jobs.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a receiving unit that receives an execution command for a process;
a classifying unit that classifies the process corresponding to the execution command as any of categories prepared in advance based on a character string included in an object to be processed in the process; and
an executing unit that executes the process in accordance with the execution command received by the receiving unit.

2. The information processing apparatus according to claim 1, further comprising:
an acquiring unit that acquires term information for each of the categories, the term information containing a preset confirmed term and a preset candidate term, the confirmed term being used for confirming that execution of the process is inappropriate, the candidate term being used for determining that the execution of the process is possibly inappropriate,
wherein the classifying unit refers to the term information to classify the process to be executed by the executing unit as any of the categories.

3. The information processing apparatus according to claim 2, further comprising:
a confirming unit that confirms whether the execution of the process classified as any of the categories as a result of corresponding to the candidate term is appropriate or inappropriate.

4. The information processing apparatus according to claim 3,
wherein the confirming unit confirms whether the execution of the process is appropriate or inappropriate in accordance with designation performed by a user.

5. The information processing apparatus according to claim 2,
wherein if the character string included in the object is included in the term information corresponding to a plurality of categories, the classifying unit classifies the process as any of the categories based on a priority level set for each category.

6. The information processing apparatus according to claim 5,
wherein if the character string included in the object is included in the term information corresponding to categories with identical priority levels, the classifying unit classifies the process as any of the categories selected by a user.

7. The information processing apparatus according to claim 1, further comprising:
a compiling unit that compiles the number of executed processes for each category.

8. The information processing apparatus according to claim 7,
wherein the compiling unit compiles the number of executed processes for each category and for each user who has commanded execution of a process.

9. The information processing apparatus according to claim 7, further comprising:
a recommending unit that recommends execution of a predetermined process if a compilation value obtained by the compiling unit exceeds a predetermined threshold value.

10. The information processing apparatus according to claim 9,
wherein the predetermined process is installation of a specific program.

11. The information processing apparatus according to claim 7, further comprising:
an output controller that controls output of a compilation result obtained by the compiling unit.

12. A non-transitory computer readable medium storing a program causing a computer to execute a process for processing information, the process comprising:
receiving an execution command for a process;
classifying the process corresponding to the execution command as any of categories prepared in advance based on a character string included in an object to be processed in the process; and
executing the process in accordance with the received execution command.

13. An information processing apparatus comprising:
receiving means for receiving an execution command for a process;
classifying means for classifying the process corresponding to the execution command as any of categories prepared in advance based on a character string included in an object to be processed in the process; and
executing means for executing the process in accordance with the execution command received by the receiving means.
